(19) United States
(12) Patent Application Publication
(10) Pub. No.: US 2025/0278054 A1
(43) Pub. Date: Sep. 4, 2025

(54) IMAGE FORMING APPARATUS

(71) Applicant: CANON KABUSHIKI KAISHA, Tokyo (JP)

(72) Inventors: TADAHISA SUGIYAMA, Ibaraki (JP); HIROMICHI KOSEKI, Saitama (JP); NAOTO TOKUMA, Chiba (JP)

(21) Appl. No.: 19/062,819

(22) Filed: Feb. 25, 2025

(30) Foreign Application Priority Data
Feb. 29, 2024 (JP) 2024-030719

(51) Int. Cl. G03G 21/16; B41J 29/02; G03G 15/00; G03G 15/16

(52) U.S. Cl. CPC G03G 21/1619; B41J 29/026; G03G 15/1605; G03G 15/6567

(57) ABSTRACT

An image forming apparatus configured to form a toner image on a recording medium includes a first frame, a conveyance roller configured to convey the recording medium, a transfer unit configured to transfer the toner image onto the recording medium, a second frame separably mounted to the first frame in a vertical direction, and a discharging unit configured to discharge the recording medium, which is conveyed from the first frame to the second frame, to an outside. At least part of the transfer unit and at least part of the conveyance roller are supported by the first frame. The discharging unit is supported by the second frame.

### BACKGROUND OF THE INVENTION

### Field of the Invention

This disclosure relates to an image forming apparatus such as a printer, a copier, a facsimile, or a multifunction machine.

### Description of the Related Art

Hitherto, in image forming apparatuses, a single main frame is constructed by integrating a plurality of sheet metals using screw fastening or welding (Japanese Patent Laid-Open No. 2021-39153). Then, various units are supported by the single main frame.

### SUMMARY OF THE INVENTION

This disclosure provides an image forming apparatus including a plurality of separable frames.

According to a first aspect of the present invention, an image forming apparatus configured to form a toner image on a recording medium, the image forming apparatus includes a first frame, a conveyance roller configured to convey the recording medium, a transfer unit configured to transfer the toner image onto the recording medium, a second frame separably mounted to the first frame in a vertical direction, and a discharging unit configured to discharge the recording medium, which is conveyed from the first frame to the second frame, to an outside. At least part of the transfer unit and at least part of the conveyance roller are supported by the first frame. The discharging unit is supported by the second frame.

According to a second aspect of the present invention, an image forming apparatus configured to form a toner image on a recording medium, includes a first frame, a photosensitive member, a transfer unit configured to transfer the toner image formed on the photosensitive member onto the recording medium, a second frame separably mounted to the first frame in a vertical direction; and a discharging unit configured to discharge the recording medium, which is conveyed from the first frame to the second frame, to an outside. The photosensitive member and at least part of the transfer unit are supported by the first frame. The discharging unit is supported by the second frame.

According to a third aspect of the present invention, an image forming apparatus configured to form an image on a recording medium using ink, includes a first frame, a conveyance roller configured to convey the recording medium, a recording unit that is supported by the first frame and is configured to eject the ink toward the recording medium, a second frame separably mounted to the first frame in a vertical direction, and a discharging unit configured to discharge the recording medium, which is conveyed from the first frame, to an outside. At least part of the conveyance roller is supported by the first frame. The discharging unit is supported by the second frame.

Further features of the present invention will become apparent from the following description of exemplary embodiments with reference to the attached drawings.

### BRIEF DESCRIPTION OF THE DRAWINGS

FIG. 1 is a schematic diagram illustrating a configuration of an image forming apparatus.

FIG. 2A is a schematic diagram illustrating a separation configuration in the image forming apparatus.

FIG. 2B is a schematic diagram illustrating the positioning of a registration roller.

FIG. 2C is a schematic diagram illustrating the positioning of a fixing apparatus.

FIG. 3A is a schematic diagram illustrating a discharging frame.

FIG. 3B is a schematic diagram illustrating an imaging frame.

FIG. 3C is a schematic diagram illustrating a supply frame.

FIG. 4A is a schematic diagram illustrating a separation configuration in the image forming apparatus.

FIG. 4B is a schematic diagram illustrating the positioning of the registration roller.

FIG. 4C is a schematic diagram illustrating the positioning of the fixing apparatus.

FIG. 5 is a schematic diagram illustrating a separation configuration in an image forming apparatus of an inkjet system.

### DESCRIPTION OF THE EMBODIMENTS

The present inventors have identified that conventional techniques, involving the assembly of various units and the like into the single main frame, have issues. For example, it is difficult to expand functions of the image forming apparatuses. Sometimes, it is necessary to replace some units of the image forming apparatuses with units that have different functions. However, the conventional single main frames are designed on the premise of supporting specific units. Therefore, in most cases, it is not possible to replace the units with alternative units. In addition, as another example, sometimes, according to diverse requirements from users, it is necessary to provide a plurality of image forming apparatuses with specifications that differ from each other. In cases of the image forming apparatuses that possess the single main frame, the main frame is designed on a zero base for each specification. This poses a bottleneck in development, design, and manufacturing.

### First Embodiment

### Image Forming Apparatus

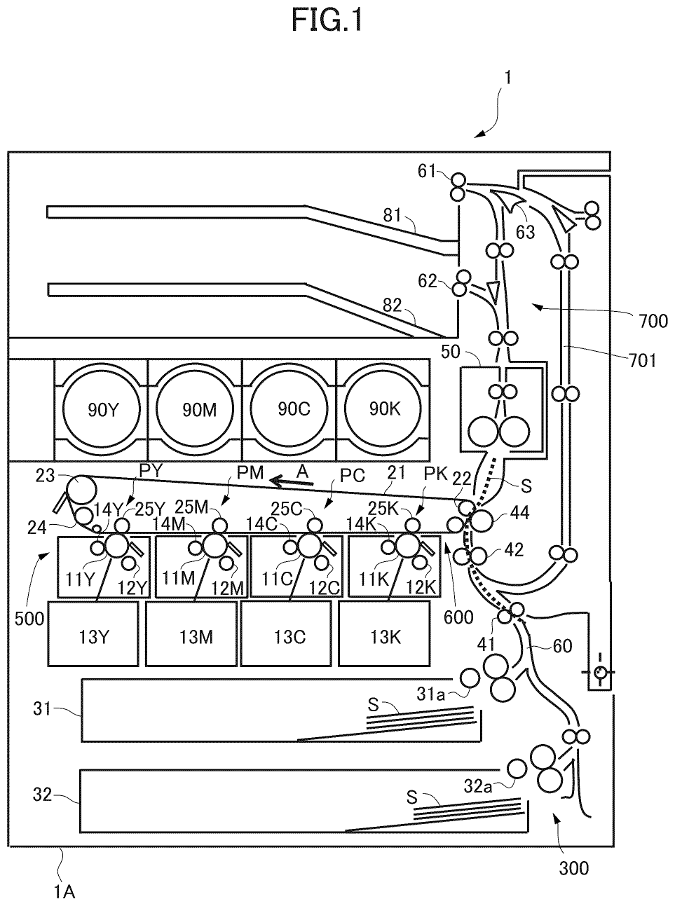

Hereinafter, this embodiment will be described. First, using FIG. 1, a schematic configuration of an image forming apparatus of this embodiment will be described. To be noted, “front” and “rear” used in the following description refer to a front side of the image forming apparatus as the front, and a rear side as the rear. “Right” and “left” correspond to the sides in a case where the apparatus is viewed from the front. The front side of the apparatus is a side on which a user operates the apparatus, and, for example, is a side on which an operation panel is arranged or from which a cassette that stores a recording material is drawn out. A “vertical direction” refers to an upper/lower direction in a state in which the image forming apparatus is installed on an installation surface such as a floor. FIG. 1 illustrates the image forming apparatus 1 as viewed from the front side.

The image forming apparatus 1 illustrated in FIG. 1 is a full color printer of an intermediate transfer system. Image forming units PY, PM, PC, and PK of four colors, which form toner images of yellow (Y), magenta (M), cyan (C), and black (K), are arranged to face an intermediate transfer belt 21. The image forming apparatus 1 includes an image formation unit 500. The image formation unit 500 forms the toner image on a recording material S based on an image signal received from a document reading unit 30, an external device (not shown) such as a personal computer, or the like. The image formation unit 500 includes the image forming units PY, PM, PC, and PK and an intermediate transfer member unit 600.

A conveyance process of the recording material S in the image forming apparatus 1 will be described. The recording material S is stored in a manner that it is stacked into one or a plurality (here, two) of cassettes 31 and 32, each serving as a storage member. The conveyance of the recording material S is started by a supply unit 300, serving as a supply unit. The supply unit 300 includes supply rollers 31a and 32a. In synchronization with the timing for image formation, the recording material S is supplied one sheet at a time from either the cassette 31 or 32 to a conveyance path 60 by the supply roller 31a or 32a. In the image forming apparatus 1 of this embodiment, the conveyance path 60 can convey the recording material S from below to above (so-called vertical conveyance method). This conveyance direction is an example, and may be configured to be a lateral direction (horizontal direction) depending on an apparatus configuration. The recording material S includes various type of sheet materials, including a paper sheet such as standard paper, thick paper, rough paper, embossed paper, and coated paper, a plastic film, cloth, and the like.

The recording material S supplied from either the cassette 31 or 32 to the conveyance path 60 is conveyed to a pre-registration roller pair 41 arranged in the middle of the conveyance path 60. With respect to the pre-registration roller pair, a registration roller pair 42 is arranged further downstream along the conveyance path 60. The pre-registration roller pair 41 and the registration roller pair 42 are serving as conveyance rollers and correct the skew of the recording material S. In particular, a leading edge of the recording material S conveyed by the pre-registration roller pair 41 abuts against a nip portion of the registration roller pair 42, which is stopping. With the leading edge of the recording material S aligned at a position of the nip portion of the registration roller pair 42, the skew correction is performed by looping or bending the recording material S. Subsequent to performing the skew correction, the registration roller pair 42 starts rotation in synchronization with the timing of secondary transfer, and conveys the recording material S. The intermediate transfer belt 21 and a secondary transfer portion are arranged above the registration roller pair 42. The registration roller pair 42 conveys the recording material S to the secondary transfer portion from below to above in synchronization with the timing at which the toner image on the intermediate transfer belt 21 is transferred onto the recording material S (timing of secondary transfer). The registration roller pair 42 is arranged at the closest position to the secondary transfer portion on an upstream side of the secondary transfer portion with respect to the conveyance direction (vertical direction) of the recording material S conveyed through the conveyance path 60. The secondary transfer portion is formed by a secondary transfer inner roller 22 and a secondary transfer outer roller 44 (second transfer unit). The secondary transfer inner and outer rollers 22 and 44 face each other across the intermediate transfer belt 21, serving as an intermediate transfer member. The secondary transfer inner roller 22 is arranged on the inside of the intermediate transfer belt 21, and the secondary transfer outer roller 44 is arranged on the outside of the intermediate transfer belt 21. These secondary transfer inner and outer rollers 22 and 44 form the secondary transfer portion, and transfer the toner image from the intermediate transfer belt 21 onto the recording material S by applying a predetermined pressure force and secondary transfer voltage.

An image forming process of the image that is sent to the secondary transfer portion at a similar timing with respect to the conveyance process described above for the recording material S up to the secondary transfer portion will be described. First, the image forming units PY to PK will be described. However, since the image forming units PY to PK are essentially the same except for the color of the toner, in the following description, the image forming unit PY for yellow will be described as a representative example.

The image forming unit PY includes a photosensitive drum 11Y, serving as a photosensitive member, a charging apparatus 12Y, serving as a charge unit, an exposing apparatus 13Y, serving as an exposing unit, and a developing apparatus 14Y, serving as a developing unit. A surface of the photosensitive drum 11Y that is rotatably driven has been uniformly charged by the charging apparatus 12Y beforehand, and, thereafter, an electrostatic latent image is formed with a laser beam emitted from the exposing apparatus 13Y that is driven based on the image signal. Then, the electrostatic latent image formed on the photosensitive drum 11Y is developed into the toner image by the developing apparatus 14Y. The developing apparatus 14Y develops the electrostatic latent image into the toner image using developer containing the toner and a carrier. To be noted, since the toner is consumed along with the development, at a suitable timing, the toner is replenished from a toner bottle 90Y, which stores the toner for replenishment, to the developing apparatus 14Y.

A primary transfer voltage is applied to the toner image formed on the photosensitive drum 11Y (on the photosensitive member) by a primary transfer roller 25Y (first transfer unit), which is arranged to face the photosensitive drum 11Y across the intermediate transfer belt 21, and the toner image is primarily transferred from the photosensitive drum 11Y onto the intermediate transfer belt 21. Primary transfer residual toner that remains on the photosensitive drum 11Y after the primary transfer is collected by a photosensitive drum cleaner.

The intermediate transfer belt 21 is an endless belt that is stretched by the secondary transfer inner roller 22, a drive roller 23, a tension roller 24, and the like, and is moved in an arrow A direction in FIG. 1. That is, the intermediate transfer belt is configured in an endless shape. The tension roller 24 is a driven roller, and, while applying tension to the intermediate transfer belt 21, is rotatably driven in conjunction with a movement of the intermediate transfer belt 21 that is driven by the drive roller 23. The image forming processes for each color, which are processed in parallel by the image forming units PY to PK described above, are performed at the timing of sequentially superimposing the toner images of each color on the toner image which has been primarily transferred upstream in the moving direction on the intermediate transfer belt. As a result, eventually, the toner image in full color is formed on the intermediate transfer belt 21, and, by the movement of the intermediate transfer belt 21, the toner image is conveyed to the secondary transfer portion. To be noted, in this embodiment, the primary transfer rollers 25Y to 25K, the intermediate transfer belt 21, the secondary transfer inner roller 22, the drive roller 23, and the tension roller 24 are configured integrally as the intermediate transfer member unit 600. However, the technology of this disclosure is not limited to this configuration.

As described above, through the conveyance process and the image forming process each described above, at the secondary transfer portion, the timing of the recording material S and the full color toner image aligns, and the secondary transfer of the toner image from the intermediate transfer belt 21 onto the recording material S is performed. Secondary transfer residual toner that remains on the intermediate transfer belt 21 after passing through the secondary transfer portion is collected from the intermediate transfer belt 21 by a belt cleaner. The recording material S onto which the toner image has been transferred is conveyed to a fixing apparatus 50 through the conveyance path 60, and, by applying heat and pressure in the fixing apparatus 50, the toner image is fixed on the recording material S. The fixing apparatus 50 includes a fixing roller, which is heated by a heater, not shown, and a pressing roller, which forms a fixing nip portion by coming into contact with the fixing roller, and fixes the toner image on the recording material S by applying the heat and pressure to the recording material S that passes through the fixing nip portion.

The recording material S on which the toner image has been fixed by the fixing apparatus 50 is conveyed further upward through the conveyance path 60, and is discharged to the outside by a sheet discharge unit 700, serving as a discharging unit. The sheet discharge unit 700 includes sheet discharge rollers 61 and 62, and the recording material S is supported on sheet discharge trays 81 and 82 by being discharged by the sheet discharge rollers 61 and 62. In this embodiment, in a case where an operation mode is a duplex mode to form the image on both surfaces of the recording material S, to form the image on an opposite surface of the recording material S, on whose one side the image has been formed, the recording material S is sent to a duplex conveyance path 701 for reversing a recording surface. In the case of the duplex mode, the recording material S is conveyed by the forward rotation of the sheet discharge roller 61 until a trailing edge passes through a flapper 63. Then, by reversing the rotation of the sheet discharge roller 61, the leading and trailing edges are interchanged, and the recording material S is conveyed to the duplex conveyance path 701. The recording material S that has been conveyed to the duplex conveyance path 701 is again returned to the registration roller pair 42. Since subsequent conveyance and image forming processes are similar to those described above, description will be omitted. The recording material S, on whose opposite surface the image has also been formed, is discharged to the outside by the sheet discharge unit 700.

### Apparatus Body

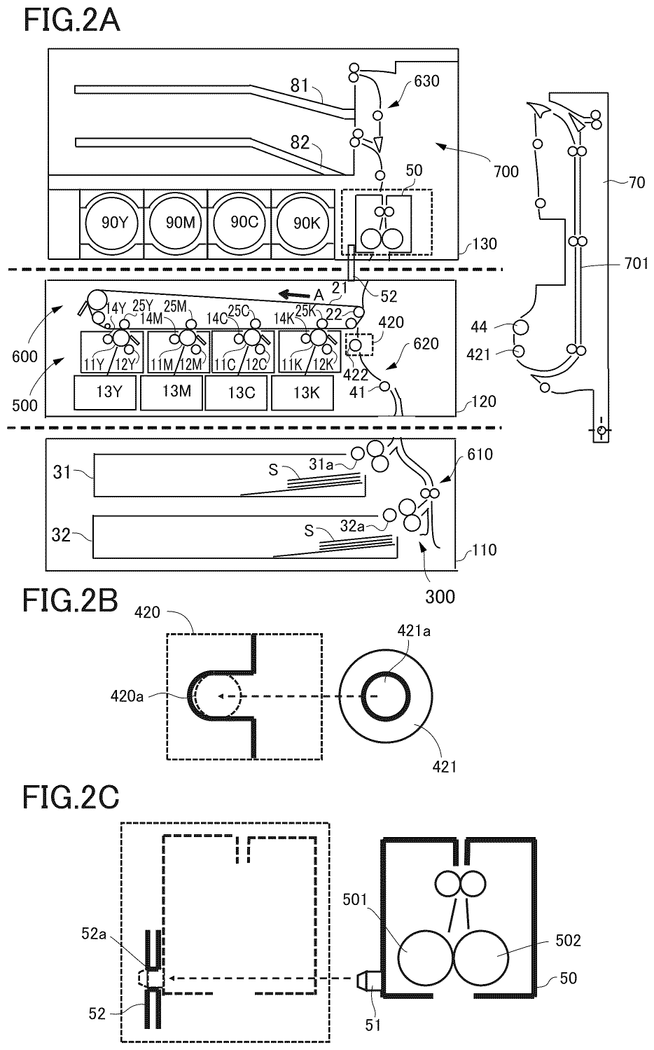

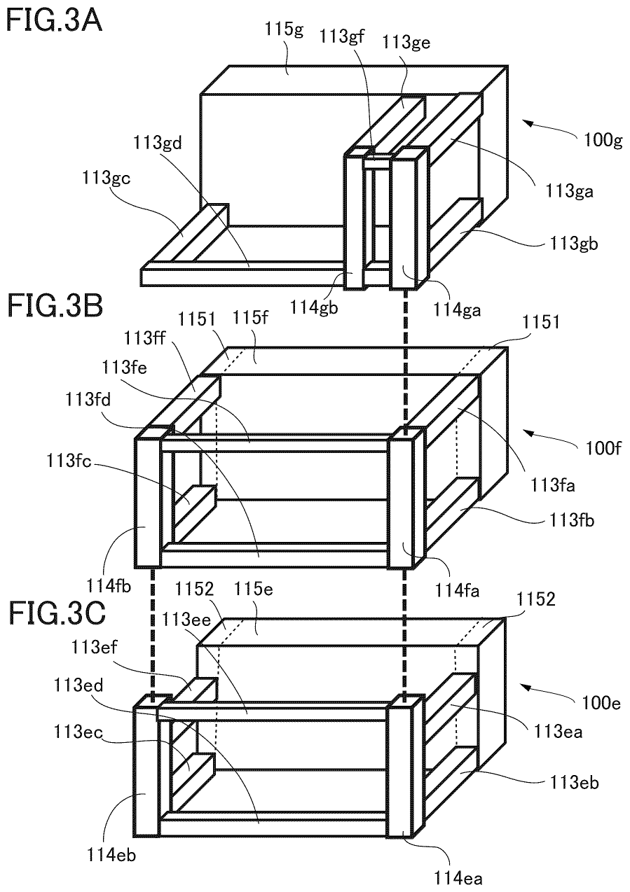

Next, using FIGS. 1 to 3C, the apparatus body 1A of this embodiment will be described. In a case of this embodiment, as illustrated in FIG. 2A, the apparatus body 1A (structure) is divided into three separable structures: a supply block 110, an imaging block 120, and a discharging block 130. To be noted, in this specification, the term “structure” refers to a state in which various units or components are mounted to a frame formed by members such as a strut and a stay (beam). In other words, the state in which the various units or the components are mounted to the frame is a state in which the various units or the components are supported by the frame. As illustrated in FIGS. 3A to 3C, the supply, imaging and discharging blocks 110, 120, and 130 respectively include a supply frame 100e, an imaging frame 100f, and a discharging frame 100g. To enable the separation of the three structures, the supply, imaging, and discharging frames 100e, 100f, and 100g are configured to be divided from each other.

Returning to FIG. 2A, in this embodiment, the apparatus body 1A, which achieves a series of functions for forming the image on the recording material S, is configured such that the imaging block 120 is stacked on top of the supply block 110 and the discharging block 130 is stacked on top of the imaging block 120. While not illustrated, the imaging and discharging blocks 120 and 130, which are in a stacked state, are connected by, for example, fastening a metallic plate-shaped member (coupling member), which bridges between vertically positioned struts, using screws. The supply and imaging blocks 110 and 120 are also similarly connected with the coupling member.

In addition, in this embodiment, a duplex conveyance block 70 (duplex conveyance unit), in which the duplex conveyance path 701 is formed, is prearranged as a separate structure from the supply, imaging, and discharging blocks 110, 120, and 130. The duplex conveyance block 70, serving as a pivot unit, is pivotably mounted with respect to the supply block 110 or the imaging block 120 so as to extend over both the imaging and discharging blocks 120 and 130. That is, boundary surfaces with the imaging and discharging blocks 120 and 130 divide the duplex conveyance block 70. The duplex conveyance block 70 forms the conveyance path 60 (refer to FIG. 1) between the imaging and discharging blocks 120 and 130. The conveyance path 60 is formed when the duplex conveyance block 70 is in a closed position, and is opened when the duplex conveyance block 70 is in an opening position. Thereby, in a case where the recording material S becomes jammed in the conveyance path 60, a user can remove the jammed recording material S by opening the duplex conveyance block 70, which can pivot to open. To open the conveyance path 60, a roller 421 on one side within the registration roller pair 42, the secondary transfer outer roller 44, and rollers on one side within roller pairs which convey the recording S in the conveyance path 60 are disposed in the duplex conveyance block 70. To be noted, in the closed state, the duplex conveyance block 70 is locked by a lock mechanism (not shown) to prevent the conveyance path 60 from being opened automatically.

### Supply, Imaging, and Discharging Blocks

The supply block 110 is a structure in which the supply unit 300 and a supply conveyance portion 610 are assembled into a supply frame 100e. In addition, supporting members (not shown) such as rail members that support the cassettes 31 and 32 slidably in a front-to-rear direction are assembled into the supply block 110. The imaging block 120 is a structure in which the image formation unit 500, including the intermediate transfer member unit 600, and an imaging conveyance portion 620 are assembled into an imaging frame 100f. The image formation unit 500 may be detachably disposed in the imaging frame 100f. In addition, a roller positioning portion 420 and a fixing position determination portion 52, described below, are assembled into the imaging block 120. The discharging block 130 is a structure in which the sheet discharge unit 700, a discharging conveyance portion 630, toner bottles 90Y, 90M, 90C, and 90K, each serving as a toner container, and the fixing apparatus 50 are assembled into a discharging frame 100g.

In this embodiment, the conveyance path 60 that conveys the recording material S from below to above is divided and formed into each of the supply, imaging, and discharging blocks 110, 120, and 130. That is, the supply conveyance portion 610 forms part of the conveyance path 60 in the supply block 110, the imaging conveyance portion 620 forms part of the conveyance path 60 in the imaging block 120, and the discharging conveyance portion 630 forms part of the conveyance path 60 in the discharging block 130.

To be noted, in this embodiment, since the vertical conveyance path 60 is adopted, the supply, imaging, and discharging blocks 110, 120, and 130 are stacked in the vertical direction. In a case where the conveyance path is in a lateral (horizontal) direction, the supply, imaging, and discharging blocks 110, 120, and 130 are arranged in line in the lateral direction. That is, a direction in which the supply, imaging, and discharging blocks 110, 120, and 130 are arranged is not limited to the vertical direction. The supply, imaging, and discharging blocks 110, 120, and 130 may be arranged in any direction in accordance with a principal direction of the conveyance path.

### Discharging, Imaging, and Supply Frames

Here, using FIGS. 3A to 3C, the discharging, imaging, and supply frames 100g, 100f, and 100e described above will be described. As illustrated in FIG. 3A, the discharging frame 100g, serving as a second frame, includes a right front strut 114ga, a rear-side plate 115g, a right upper stay 113ga, a right lower stay 113gb, a left stay 113gc, and a front stay 113gd. The right front strut 114ga is extended in the vertical direction. The right upper and lower stays 113ga and 113gb are arranged in the vertical direction with respect to the right front strut 114ga, are arranged substantially parallel to each other, and each connect the right front strut 114ga with the rear-side plate 115g. The left stay 113gc is arranged in a direction substantially perpendicular to the rear-side plate 115g such that the left stay 113gc is arranged substantially parallel and opposite to the right lower stay 113gb. The front stay 113gd is arranged in a direction (lateral direction) parallel to the rear-side plate 115g such that the front stay 113gd connects the left stay 113gc and the right front strut 114ga.

In addition, the discharging frame 100g includes a front strut 114gb, an upper stay 113ge, and a right upper stay 113gf. The right strut 114gb is arranged further to the right than the center of the front stay 113gd between the left stay 113gc and the right lower stay 113gb in the lateral direction, and is arranged substantially parallel to the right front strut 114ga. The front strut 114gb is connected to the front stay 113gd. The upper stay 113ge is arranged substantially parallel to the right upper stay 113ga such that the upper stay 113ge connects the front strut 114gb and the rear-side plate 115g. The right upper stay 113gf is arranged substantially parallel to the front stay 113gd such that the right upper stay 113gf connects the right front strut 114ga and the front strut 114gb. The sheet discharge unit 700 described above is assembled into a space secured by these struts 114ga and 114gb, stays 113ga, 113gb, 113ge, and 113gf, and rear-side plate 115g.

As illustrated in FIG. 3B, the imaging frame 100f, serving as a first frame, includes a right front strut 114fa, a left front strut 114fb, a rear-side plate 115f, a right upper stay 113fa, a right lower stay 113fb, a left upper stay 113ff, a left lower stay 113fc, a front upper stay 113fe, and a front lower stay 113fd. The right front strut 114fa is extended in the vertical direction. The right upper and lower stays 113fa and 113fb are arranged in the vertical direction with respect to the right front strut 114fa, are arranged substantially parallel to each other, and each connect the right front strut 114fa and the rear-side plate 115f. The left front strut 114fb is extended in the vertical direction such that the left front strut 114fb is arranged substantially parallel and opposite to the right front strut 114fa. The left upper and lower stays 113ff and 113fc are arranged in the vertical direction with respect to the left front strut 114fb, are arranged substantially parallel to each other, and each connect the left front strut 114fb and the rear-side plate 115f. The front upper stay 113fe is arranged in a direction (lateral direction) parallel to the rear side plate 115f such that the front upper stay 113fe connects the right and left front struts 114fa and 114fb at their upper end portions. The front lower stay 113fd is arranged in the direction (lateral direction) parallel to the rear-side plate 115f such that the front lower stay 113fd connects the right and left front struts 114fa and 114fb at their lower end portions. In the imaging frame 100f, to enhance strength as the frame, the right front strut 114fa, the left front strut 114fb, and reinforcement members 1151, which correspond to struts disposed in the rear-side plate 115f, are arranged at four corners of the frame. In the rear-side plate 115f, the reinforcement members 1151 are disposed at both end portions in the lateral direction.

As illustrated in FIG. 3C, the supply frame 100e, serving as a third frame, includes a right front strut 114ea, a left front strut 114eb, a rear-side plate 115e, a right upper stay 113ea, a right lower stay 113eb, a left upper stay 113ef, a left lower stay 113ec, a front upper stay 113ee, and a front lower stay 113ed. The right front strut 114ea is extended in the vertical direction. The right upper and lower stays 113ea and 113eb are arranged in the vertical direction with respect to the right front strut 114ea, are arranged substantially parallel to each other, and each connect the right front strut 114ea and the rear-side plate 115e. The left front strut 114eb is extended in the vertical direction such that the left front strut 114eb is arranged substantially parallel and opposite to the right front strut 114ea. The left upper and lower stays 113ef and 113ec are arranged in the vertical direction with respect to the left front strut 114eb, are arranged substantially parallel to each other, and each connect the left front strut 114eb and the rear-side plate 115e. The front upper stay 113ee is arranged in a direction (lateral direction) parallel to the rear-side plate 115e such that the front upper stay 113ee connects the right and left front struts 114ea and 114eb at their upper end portions. The front lower stay 113ed is arranged in the direction (lateral direction) parallel to the rear-side plate 115e such that the front lower stay 113ed connects the right and left front struts 114ea and 114eb at their lower end portions. To be noted, in the vertical direction, a connecting position of the right upper stay 113ea with respect to the right front strut 114ea and a connecting position of the left upper stay 113ef with respect to the left front strut 114eb are below connecting positions of the front upper stay 113ee with respect to the right and left front struts 114ea and 114eb. In the supply frame 100e, to ensure strength as the frame, the right front strut 114ea, the left front strut 114eb, and reinforcement members 1152, which correspond to struts disposed in the rear-side plate 115e, are arranged at four corners of the frame. In the rear-side plate 115e, the reinforcement members 1152 are disposed at both end portions in the lateral direction.

An example of a method for connecting the imaging and supply blocks 120 and 110 will be described. As illustrated in FIGS. 3B and 3C, the right front strut 114fa of the imaging frame 100f is placed on the right front strut 114ea of the supply frame 100e, and the left front strut 114fb of the imaging frame 100f is placed on the left front strut 114eb of the supply frame 100e. Further, the reinforcement members 1151 of the rear-side plate 115f of the imaging frame 100f are placed on the reinforcement members 1152 of the rear-side plate 115e of the supply frame 100e. In this state, the imaging and supply blocks 120 and 110 are connected with the coupling member, not shown. To be noted, it is acceptable to configure the setup such that, without employing the coupling member, the imaging block 120 is merely placed on top of the supply block 110.

An example of a method for connecting the imaging and discharging blocks 120 and 130 will be described. As illustrated in FIGS. 3A and 3B, the right front strut 114ga of the discharging frame 100g is placed on the right front strut 114fa of the imaging frame 100f, and reinforcement members (not shown) of the rear-side plate 115g of the discharging frame 100g are placed on the reinforcement members 1151 of the rear-side plate 115f of the imaging frame 100f. In this state, the imaging and discharging blocks 120 and 130 are connected with the coupling member, not shown. As described above, the coupling member may not be employed.

As described above, the discharging, imaging, and supply frames 100g, 100f, and 100e, into each of which respective units, components, and the like have been assembled, are stacked and connected in the vertical direction. With this configuration, it is possible to provide the image forming apparatus 1 that allows the apparatus body 1A to be divided into a plurality of blocks. A technical advantage of a main frame structure being separable into the plurality of blocks has several aspects; examples are provided below.

As one aspect of the technical advantage described above, in a plurality of image forming apparatuses, it is possible to use a common discharging block 130 and a common supply block 110 while, on the other hand, it is possible to use imaging blocks 120 that differ in configuration for each of the plurality of image forming apparatuses. Thereby, only the imaging block 120 needs to be designed for each apparatus, which enables the reduction of the burden on development, design, or manufacturing. Alternatively, regarding an image forming apparatus originally equipped with a monochrome imaging block 120, it is possible to expand functions of the image forming apparatus by replacing the imaging block 120 with a color imaging block 120.

In addition, as another aspect of the technical advantage described above, it is possible to assemble the apparatus body 1A by stacking the supply, imaging, and discharging blocks 110, 120, and 130, into which various units and components have been assembled for each block. With this configuration, assembly man-hours for the apparatus body 1A are significantly reduced, and it is also possible to improve the product quality of the apparatus body 1A.

That is, in a case where the apparatus body 1A is assembled by mounting units and components to a pre-formed single main frame, while there is an advantage of being able to ensure accurate positioning of each unit by relying on the rigidity and strength of the main frame, conversely, it is difficult and labor-intensive to mount the units and components. For example, in a case of mounting a unit to the rear of the main frame, it is necessary to mount the unit by maneuvering around struts and stays of the main frame, and there is a risk that, due to workability in such a mounting process, the product quality of the apparatus body 1A may decrease. In addition, the assembly man-hours are lengthened for mounting numerous units and components with respect to the single main frame, and, further, since an assembly method relies on the proficiency of a worker, there is a variation in the assembly man-hours, which eventually increases production costs.

In contrast, in this embodiment, the apparatus body 1A can be assembled by dividing it into the supply, imaging, and discharging blocks 110, 120, and 130. Thereby, since the units and components can be assembled for each of the supply, imaging, and discharging blocks 110, 120, and 130, it is possible to significantly reduce the assembly man-hours for the apparatus body 1A, and also improve the product quality of the apparatus body 1A. Further, since it is simple to add and assemble units (such as a second fixing apparatus), which implement new functions, into the supply, imaging, and discharging frames 100e, 100f, and 100g by dividing the apparatus body 1A into the supply, imaging, and discharging blocks 110, 120, and 130, it is straightforward to expand the functions of the image forming apparatus 1.

### Second Embodiment

As a second embodiment, an image forming apparatus that can further improve the positioning accuracy of units and components assembled into the apparatus body 1A will be described. To be noted, all configurations described as the first embodiment are applied to the second embodiment. Therefore, repetitive description will be omitted.

Similar to the first embodiment described above, in this embodiment, the supply, imaging, and discharging frames 100e, 100f, and 100g, into each of which units and components have been assembled, are stacked vertically and connected. However, in this case, compared with a case of a conventional method in which the apparatus body 1A is assembled by mounting various units and the like to a single main frame, it is difficult to ensure relative positional relationships among the units assembled into the discharging, imaging, and supply frames 100g, 100f, and 100e. This is because, in a case of considering the positional tolerance of a different shape from a reference shape, while it is possible to directly define dimensions in a case of a single component, in a case of defining the dimensions across a plurality of components, the tolerance accumulates with the number of intermediary components. For example, when considering the positioning accuracy between components, if the main frame is a single unit, the dimensions between components can be directly defined, but, if the main frame is divided into a plurality of frames, the positioning accuracy between components mounted to different frames is affected by the positional tolerances between the frames. Therefore, in this embodiment, areas in which the enhancement of the positioning accuracy especially largely contributes to the improvement of image formation quality will be described with examples.

### Roller Positioning Portion

As illustrated in FIG. 2A, the duplex conveyance block 70 is arranged to extend over the imaging and discharging blocks 120 and 130. Then, the secondary transfer outer roller 44, disposed in the duplex conveyance block 70, forms the secondary transfer portion by sandwiching the intermediate transfer belt 21, disposed in the imaging block 120, with the secondary transfer inner roller 22. In addition, the roller 421 is detachably disposed in the duplex conveyance block 70 with respect to the imaging frame 100f. When the roller 421 (second roller) disposed in the duplex conveyance block 70 comes into contact with a roller 422 (first roller) disposed in the imaging block 120, the registration roller pair 42 (refer to FIG. 1) is formed. The registration roller pair 42 conveys the recording material S to the secondary transfer portion in synchronization with the timing at which the toner image on the intermediate transfer belt 21 is transferred onto the recording material S. Therefore, if there are errors in positioning (alignment error) between the rollers 421 and 422, it is not possible to convey the recording material S in a proper posture, and this may cause transfer defects during the transfer of the toner image onto the recording material S.

Therefore, in this embodiment, the roller positioning portion 420 is disposed in the imaging block 120 to correctly position the registration roller pair 42 with respect to the secondary transfer portion without causing misalignment between the rollers 421 and 422. As illustrated in FIG. 2B, a concave portion 420a that rotatably holds a shaft portion 421a of the roller 421 disposed in the duplex conveyance block 70 is formed in the roller positioning portion 420. The roller positioning portion 420 determines a position of the roller 421 during the mounting of the roller 421. Thereby, by disposing the roller positioning portion 420 for the registration roller pair 42, even if the apparatus body 1A is formed by stacking the plurality of separable blocks, it is possible to reduce the likelihood of the occurrence of the transfer defects due to the alignment error of the rollers.

To be noted, while, in FIG. 2B, an example where the roller positioning portion 420 engages with the shaft portion 421a of the roller 421 is illustrated, it is not limited to this. For example, by disposing an engagement projection portion in the duplex conveyance block 70, which includes the roller 421, it is acceptable to dispose an engaged portion, which engages with the engagement projection portion, in the imaging block instead of the roller positioning portion 420. In this case, the alignment error that occurs between the rollers 421 and 422 is reduced by engaging the engaged portion of the imaging block with the engagement projection portion of the duplex conveyance block 70, and it is possible to correctly position the registration roller pair 42 with respect to the secondary transfer portion.

In addition, it is acceptable to dispose a roller positioning portion, which is similar to the roller positioning portion 420 disposed with respect to the roller 421, with respect to the secondary transfer outer roller 44. With this configuration, it is possible to reduce the alignment error between the secondary transfer inner and outer rollers 22 and 44. Since, consequently, it is possible to enhance the positional accuracy of the secondary transfer portion, it is possible to improve the accuracy of the relative position between the secondary transfer portion and the registration roller pair 42. To be noted, it is acceptable to dispose only one of either the roller positioning portion 420 disposed with respect to the roller 421 or the roller positioning portion disposed with respect to the secondary transfer outer roller 44.

### Fixing Position Determination Portion

In addition, in this embodiment, as illustrated in FIG. 2A, since the fixing apparatus 50 is disposed in the discharging block 130, the recording material S onto which the toner image has been transferred is delivered from the imaging block 120 to the discharging block 130, and is conveyed to the fixing apparatus 50. As illustrated in FIG. 2C, the fixing apparatus 50 includes the fixing roller 501 and the pressing roller 502, and the pressing roller 502 comes into contact with the fixing roller 501 to form a fixing nip portion for fixing the toner image on the recording material S. Therefore, to properly fix the toner image on the recording material S, it is necessary to convey the recording material S, which has passed through the secondary transfer portion, to the fixing nip portion of the fixing apparatus 50 in a correct posture.

Therefore, in this embodiment, in a case of mounting the discharging block 130 to the imaging block 120, a fixing position determination portion 52 is disposed in the imaging block 120 to correctly position the fixing apparatus 50, which is mounted to the discharging block 130, with respect to the imaging conveyance portion 620, through which the recording material S is conveyed in the imaging block 120. As illustrated in FIG. 2A, the fixing position determination portion 52 protrudes upward from the imaging block 120 toward the discharging block 130 to enter into the discharging block 130 in a state in which the discharging block 130 is mounted to the imaging block 120. As illustrated in FIG. 2C, a protruding portion 51 is disposed on the fixing apparatus 50, and an engaging hole 52a is formed in the fixing position determination portion 52. When the protruding portion 51 is engaged with the engaging hole 52a, the fixing apparatus 50 is correctly positioned with respect to the imaging conveyance portion 620 of the imaging block 620. In this manner, by disposing the fixing position determination portion 52 of the fixing apparatus 50 in the imaging block 120, even if the apparatus body 1A is formed by stacking the plurality of separable blocks, the recording material S that has passed through the secondary transfer portion is conveyed to the fixing nip portion of the fixing apparatus 50 in the correct posture.

### Variant Example of Fixing Position Determination Portion

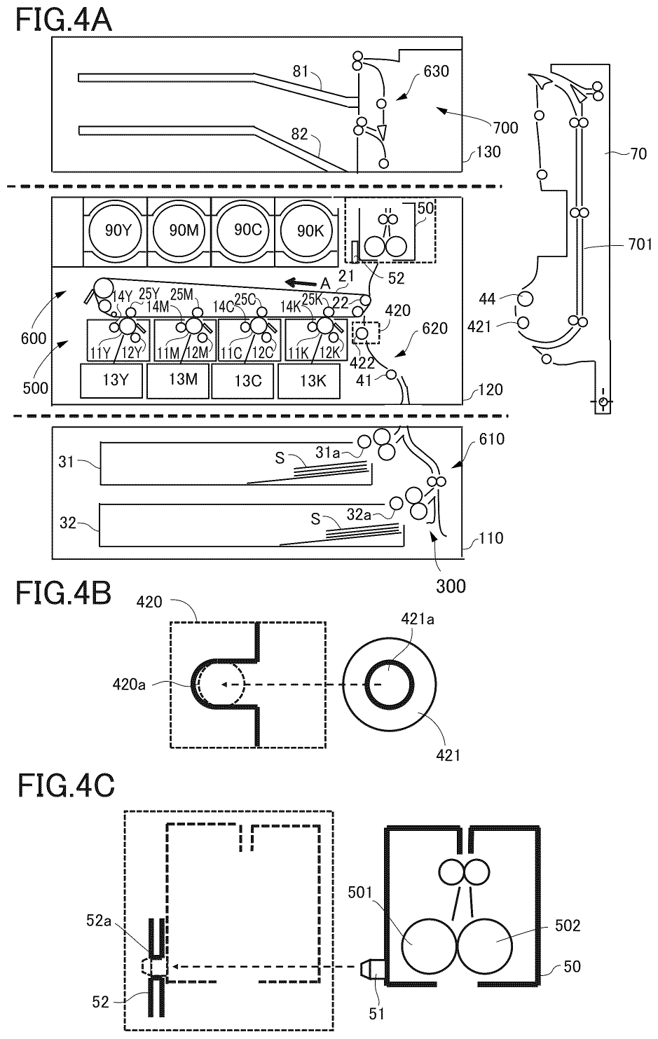

Next, with reference to FIG. 1, a variant example of the fixing position determination portion will be described using FIGS. 4A to 4C. To be noted, in FIGS. 4A to 4C, configurations similar to those illustrated in FIGS. 1 to 3C are marked with the same reference characters, and description will be simplified or omitted.

As illustrated in FIG. 4A, the apparatus body 1A (structure) is divided into the three separable structures: supply, imaging, and discharging blocks 110, 120, and 130. That is, the apparatus body 1A, which implements the series of the functions to form the image on the recording material S, is configured such that the imaging block is stacked on top of the supply block 110, and the discharging block 130 is stacked on top of the imaging block 120. However, as can be noted when comparing FIG. 4A and FIG. 2A, the toner bottles 90Y to 90K and the fixing apparatus 50 are assembled into the imaging block 120 (in particular, the imaging frame 100f (refer to FIG. 3)). The supply block 110 and the duplex conveyance block 70 are similar to those in the first embodiment.

The imaging block 120 is a structure in which the image formation unit 500, the imaging conveyance portion 620, the toner bottles 90Y to 90K, and the fixing apparatus 50 are assembled into the imaging frame 100f described above. In addition, the roller positioning portion 420 and the fixing position determination portion 52 are assembled into the imaging block 120. As illustrated in FIG. 4B, the roller positioning portion 420 has the same configuration as the second embodiment described above. In addition, as illustrated in FIG. 4C, the fixing position determination portion 52 may also have the same configuration as the second embodiment described above. However, while, in a case of the second embodiment, the fixing position determination portion 52 protrudes above the imaging frame 100f to enter into the discharging block 130 (refer to FIG. 2A), in a case of the variant example of the second embodiment, the fixing apparatus 50 is detachably disposed in the imaging frame 100f, and the fixing position determination portion 52 does not protrude above the imaging frame 100f but is contained within the imaging frame 100f (within first frame).

As described above, in the variant example of the second embodiment, with the fixing apparatus 50 pre-positioned by the fixing position determination portion 52, the discharging block 130 is stacked and mounted on top of the imaging block 120 into which the fixing apparatus has been assembled. Thereby, since it is possible to enhance efficiency in the assembly process, it is possible to attain effects of improving the product quality of the apparatus body 1A and making it easier to expand the functions of the image forming apparatus 1.

### Mounting of Photosensitive Drum, Transfer Unit, and Conveyance Roller

Next, another technique for improving the positioning accuracy in this embodiment will be described. As illustrated in FIG. 2A, part of the intermediate transfer member unit 600 and part of conveyance rollers for conveying the recording material S are supported by the imaging frame 100f (refer to FIG. 3B). In particular, the secondary transfer inner roller 22 of the intermediate transfer member unit 600 is supported by the imaging frame 100f, and the roller 422 on one side within the registration roller pair 42 is supported by the imaging frame 100f. As described above, the registration roller pair 42 conveys the recording material S in synchronization with the timing at which the toner image on the intermediate transfer belt 21 is transferred onto the recording material S. According to this configuration, since the accuracy of a relative distance from the registration roller pair 42 to the secondary transfer portion is enhanced, it is possible to reduce the likelihood of the occurrence of the transfer defects during the transfer of the toner image onto the recording material S. Furthermore, by assembling the roller positioning portions for the roller 421 and the secondary transfer outer roller 44 into the imaging frame 100f, it is possible to further improve the positioning accuracy.

A further alternative technique to improve the positioning accuracy in this embodiment will be described. As illustrated in FIG. 2A, the photosensitive drum 11K and part of the intermediate transfer member unit 600 are supported by the imaging frame 100f (refer to FIG. 3B). In particular, with respect to the intermediate transfer member unit 600, the primary transfer rollers 25 of the intermediate transfer member unit 600 are supported by the imaging frame 100F. To be noted, since colors are not distinguished here, the ending marks “Y, M, C, K” in the reference characters are omitted. As described above, the toner images of the plurality of colors are superimposed on the intermediate transfer belt 21. Therefore, when primary transfer portions of each color are arranged in exact positions, it becomes possible to reduce color misregistration.

As described above, in the second embodiment, several techniques for improving the positioning accuracy are described. These techniques can be combined as needed to suit objectives and use cases. For example, even if the roller positioning portion is not disposed, when a single frame supports part of the intermediate transfer member unit 600 and part of the photosensitive drums or the conveyance rollers, it is possible to achieve quality improvement through the enhancement of the positional accuracy.

In addition, when the two elements described above is supported by the single frame, even if the other elements are supported by other frames, it is possible to achieve the quality improvement of the formed image through the enhancement of the positional accuracy. As an example, as described above, the secondary transfer inner roller 22 of the intermediate transfer member unit 600 is supported by the imaging frame 100f, and the roller 422 on one side within the registration roller pair 42 is supported by the imaging frame 100f. At this time, all elements of the intermediate transfer member unit 600, except for the secondary transfer inner roller 22, may be supported by the discharging frame 100g (refer to FIG. 3A). As a structure for this purpose, with respect to the fixing apparatus 50, this specification describes the positioning configuration in which components contained within the discharging frame 100g are supported by other frames such as the imaging frame 100f. A configuration similar to that used for the positioning of the fixing apparatus 50 is used.

To be noted, while, in the first and second embodiments described above, as an example, the exposing apparatuses 13Y to 13Y are disposed in the imaging block 120, it is not limited to this, and the exposing apparatuses 13Y to 13K may be disposed in the discharging block 130.

To be noted, while, in the first and second embodiments described above, as an example, the image forming apparatus 1 utilizes the intermediate transfer system in which, after primarily transferring the toner images of each color from the photosensitive drums 11Y to 11K of each color to the intermediate transfer belt 21, the toner images of each color are secondarily transferred onto the recording material S, it is not limited to this. For example, the image forming apparatus may utilize a direct transfer system in which nip portions are formed between a conveyance belt and photosensitive drums, and toner images on the photosensitive drums are directly transferred onto a sheet (recording material S), which is conveyed by the conveyance belt, by applying voltage to transfer rollers that face the photosensitive drums across the conveyance belt.

### Third Embodiment

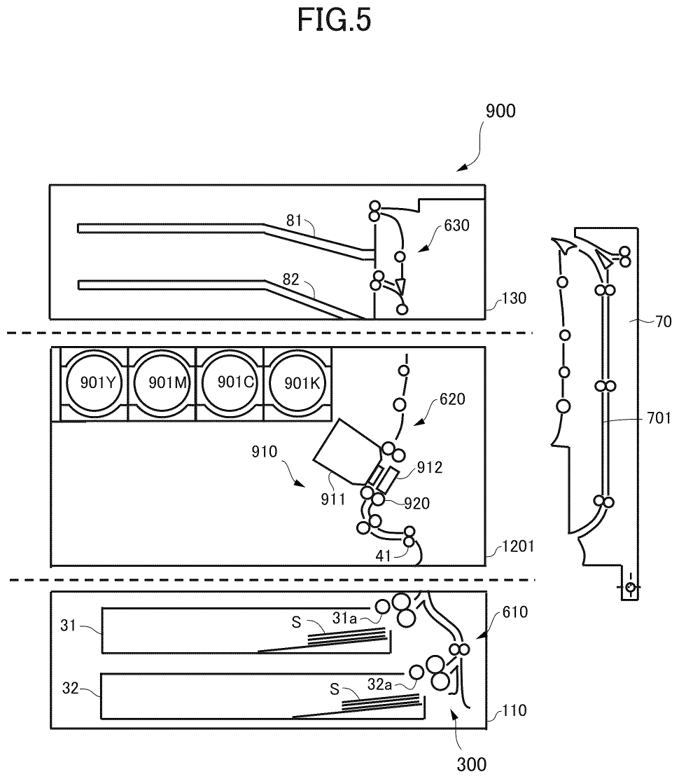

Next, a third embodiment will be described. This disclosure is not limited to the image forming apparatus of the electrophotographic system described above, but may also be applied to an image forming apparatus of an inkjet system. FIG. 5 illustrates a separation configuration in the image forming apparatus of the inkjet system as the third embodiment. To be noted, in the third embodiment, regarding configurations similar to those of the second embodiment described above, by applying the same reference characters, description will be simplified or omitted. In the third embodiment, the supply and discharging blocks 110 and 130 are similar to those of the second embodiment. With respect to the duplex conveyance block 70, it differs from the second embodiment as the secondary transfer outer roller 44 and the roller 421 are not provided.

As illustrated in FIG. 5, also in the third embodiment, as with the second embodiment, an apparatus body (structure) of the inkjet printer 900 is divided into three separable structures: supply, imaging, and discharging blocks 110, 1201, and 130. That is, also in the third embodiment, the apparatus body that implements a series of functions to form the image on the recording material S is configured such that the imaging block 1201 is stacked on top of the supply block 110, and the discharging block 130 is stacked on top of the imaging block 1201.

In a case of the inkjet printer 900, the imaging block 1201 is a structure in which a recording unit 940, a load feeder (LF) roller pair 920, and the imaging conveyance portion 620 are assembled into the imaging frame 100f (refer to FIG. 2B). The skew and a position of the recording material S conveyed from the supply block 110 are corrected by the LF roller pair 920, and the recording material S is conveyed to the recording unit 940. That is, the LF roller pair 920 is the conveyance roller corresponding to the registration roller pair 42 described above. The recording unit 940 includes a recording head 911, which ejects ink onto the recording material S, and a platen 912, which supports the recording material S from the rear at a position facing the recording head 911. Therefore, both the recording head 911 and the platen 912 are supported by the frame of the imaging block 120. The recording head 911 includes five line-type recording heads corresponding to four ink colors: yellow (Y), magenta (M), cyan (C), and black (K), along with a reaction liquid. The LF roller pair 920 is correctly positioned with respect to a gap between the recording head 911 and the platen 912 without causing misalignment between a pair of rollers.

To be noted, while, in FIG. 5, ink bottles 901Y, 901M, 901C, and 901K for supplying the ink to corresponding line-type recording heads are arranged in the imaging block 1201, it is not limited to this, and the ink bottles 901Y, 901M, 901C, and 901K may be arranged in the discharging block 130. As described above, also in the inkjet printer 900, the apparatus body 1A can be assembled by dividing it into the supply, imaging, and discharging blocks 110, 1201, and 130. Thereby, it becomes possible to assemble units and components for each of the supply, imaging, and discharging blocks 110, 1201, and 130, so that the assembly man-hours for the apparatus body 1A can be significantly reduced and the product quality of the apparatus body 1A can be improved. Further, since it is simple to add and assemble units that implement new functions, it is straightforward to expand the functions of the image forming apparatus 1.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-030719, filed on Feb. 29, 2024, which is hereby incorporated by reference herein in its entirety.

What is claimed is:

1. An image forming apparatus configured to form a toner image on a recording medium, the image forming apparatus comprising:
a first frame;
a conveyance roller configured to convey the recording medium;
a transfer unit configured to transfer the toner image onto the recording medium;
a second frame separably mounted to the first frame in a vertical direction; and
a discharging unit configured to discharge the recording medium, which is conveyed from the first frame to the second frame, to an outside,
wherein at least part of the transfer unit and at least part of the conveyance roller are supported by the first frame, and
wherein the discharging unit is supported by the second frame.

2. The image forming apparatus according to claim 1, further comprising:
a photosensitive member that is supported by the first frame,
wherein the transfer unit is configured to transfer the toner image formed on the photosensitive member onto the recording medium.

3. The image forming apparatus according to claim 2,
wherein the transfer unit includes
an intermediate transfer member,
a first transfer unit configured to transfer the toner image from the photosensitive member to the intermediate transfer member, and
a second transfer unit configured to transfer the toner image from the intermediate transfer member to the recording medium.

4. The image forming apparatus according to claim 3,
wherein the transfer unit includes a drive roller and a driven roller that are configured to stretch the intermediate transfer member, and
wherein the drive roller and the driven roller are supported by the first frame.

5. The image forming apparatus according to claim 3,
wherein the first transfer unit includes a primary transfer roller configured to transfer the toner image formed on the photosensitive member onto the intermediate transfer member, and
wherein the primary transfer roller is supported by the first frame.

6. The image forming apparatus according to claim 3,
wherein the transfer unit includes a drive roller and a driven roller that are configured to stretch the intermediate transfer member, and
wherein the first transfer unit includes a primary transfer roller configured to transfer the toner image formed on the photosensitive member onto the intermediate transfer member, and
wherein the drive roller, the driven roller, and the primary transfer roller are supported by the first frame.

7. The image forming apparatus according to claim 3,
wherein the intermediate transfer member includes an endless intermediate transfer belt,
wherein the second transfer unit includes an inner roller arranged on an inside of the intermediate transfer belt, and an outer roller arranged on an outside of the intermediate transfer belt,
wherein the toner image on the intermediate transfer belt is transferred onto the recording medium by the inner roller and the outer roller, and
wherein the inner roller is supported by the first frame.

8. The image forming apparatus according to claim 7, further comprising:
a pivot unit that is configured to support the outer roller and is configured to pivot between an opening position and a closed position with respect to the first frame.

9. The image forming apparatus according to claim 8, further comprising:
a roller positioning portion that is supported by the first frame and is configured to determine a position of the outer roller when the pivot unit is in the closed position.

10. The image forming apparatus according to claim 8, further comprising:
a roller positioning portion,
wherein the conveyance roller includes a roller pair including a first roller supported by the first frame and a second roller supported by the pivot unit, and
wherein the roller positioning portion is supported by the first frame and is configured to determine a position of the second roller when the pivot unit is in the closed position.

11. The image forming apparatus according to claim 10,
wherein the roller pair is configured to correct skew of the recording medium by coming into contact with the conveyed recording medium in a state in which the roller pair is stopped.

12. The image forming apparatus according to claim 1,
wherein the conveyance roller includes a roller pair including a first roller supported by the first frame and a second roller that is configured to be detachably mounted with respect to the first frame, and
wherein the first frame includes a roller positioning portion configured to determine a position of the first roller.

13. The image forming apparatus according to claim 12,
wherein the roller pair is configured to correct skew of the recording medium by coming into contact with the conveyed recording medium in a state in which the roller pair is stopped.

14. The image forming apparatus according to claim 1, further comprising:
a fixing unit that is supported by the first frame and is configured to fix the toner image on the recording medium,
wherein the fixing unit is detachably mounted with respect to the first frame, and
wherein the first frame includes a position determination portion configured to determine a position of the fixing unit.

15. The image forming apparatus according to claim 1, further comprising:
a fixing unit configured to fix the toner image on the recording medium,
wherein the fixing unit is supported by the first frame and is arranged inside of the second frame, and
wherein the first frame includes a position determination portion that is configured to determine a position of the fixing unit and protrudes into inside of the second frame.

16. The image forming apparatus according to claim 1, further comprising:
a photosensitive member;
a charge unit configured to charge the photosensitive member,
an exposing unit configured to form an electrostatic latent image by exposing the photosensitive member that has been charged; and
a developing unit configured to develop the electrostatic latent image on the photosensitive member to the toner image,
wherein at least one of the charge unit, the developing unit, and the exposing unit is supported within the first frame.

17. The image forming apparatus according to claim 16, further comprising:
a toner container configured to store toner that is replenished to the developing unit,
wherein the toner container is supported by the second frame.

18. The image forming apparatus according to claim 16, further comprising:
a toner container configured to store toner that is replenished to the developing unit,
wherein the toner container is supported by the first frame.

19. The image forming apparatus according to claim 1,
wherein the conveyance roller includes a pre-registration roller pair and a registration roller pair arranged downstream of the pre-registration roller pair in a conveyance path,
wherein, the registration roller pair is configured to correct skew of the recording medium when the pre-registration roller pair conveys the recording medium in a state in which the registration roller pair is stopped, and
wherein at least part of the registration roller pair is supported by the first frame.

20. The image forming apparatus according to claim 1, further comprising:
a storage member configured to store the recording medium;
a supply unit configured to supply the recording medium from the storage member toward an inside of the first frame; and
a third frame separably mounted to the first frame in the vertical direction,
wherein the storage member and the supply unit are supported by the third frame.

21. The image forming apparatus according to claim 1, further comprising:
a coupling member configured to connect the first frame and the second frame.

22. The image forming apparatus according to claim 1, further comprising:
a duplex conveyance unit configured to reverse a recording surface of the recording medium,
wherein the duplex conveyance unit is arranged to extend over the first frame and the second frame.

23. An image forming apparatus configured to form a toner image on a recording medium, the image forming apparatus comprising:
a first frame;
a photosensitive member;
a transfer unit configured to transfer the toner image formed on the photosensitive member onto the recording medium;
a second frame separably mounted to the first frame in a vertical direction; and
a discharging unit configured to discharge the recording medium, which is conveyed from the first frame to the second frame, to an outside,
wherein the photosensitive member and at least part of the transfer unit are supported by the first frame, and
wherein the discharging unit is supported by the second frame.

24. The image forming apparatus according to claim 23, further comprising:
conveyance rollers configured to convey the recording medium,
wherein at least part of the conveyance rollers is supported by the first frame.

25. An image forming apparatus configured to form an image on a recording medium using ink, the image forming apparatus comprising:
a first frame;
a conveyance roller configured to convey the recording medium;
a recording unit that is supported by the first frame and is configured to eject the ink toward the recording medium;
a second frame separably mounted to the first frame in a vertical direction; and
a discharging unit configured to discharge the recording medium, which is conveyed from the first frame, to an outside,
wherein at least part of the conveyance roller is supported by the first frame, and
wherein the discharging unit is supported by the second frame.

26. The image forming apparatus according to claim 25, further comprising:
a storage member configured to store the recording medium;
a supply unit configured to supply the recording medium from the storage member toward an inside of the first frame; and
a third frame separably mounted to the first frame in a vertical direction,
wherein the storage member and the supply unit are supported by the third frame.

27. The image forming apparatus according to claim 25,
wherein the recording unit includes a recording head that is configured to eject the ink, and a platen that is arranged to face the recording head and is configured to support the recording medium from a rear in a position facing the recording head, and
wherein both the recording head and the platen are supported by the first frame.
